(19) United States
(12) Patent Application Publication
(10) Pub. No.: US 2012/0100302 A1
(43) Pub. Date: Apr. 26, 2012

(54) METHOD FOR PRODUCING POLYCRYSTALLINE SILICON RODS

(75) Inventors: Laszlo FABRY, Burghausen (DE); Thomas ALTMANN, Haiming (DE); Heinz KRAUS, Zeilarn (DE)

(73) Assignee: WACKER CHEMIE AG, Muenchen (DE)

(21) Appl. No.: 13/267,111

(22) Filed: Oct. 6, 2011

(30) Foreign Application Priority Data
Oct. 25, 2010 (DE) 10 2010 042869.8

(51) Int. Cl. B05D 3/10

(52) U.S. Cl. 427/534

(57) ABSTRACT

The invention relates to a method for producing polycrystalline silicon rods by deposition of silicon on at least one thin rod in a reactor, wherein, before the silicon deposition, hydrogen halide at a temperature of 400-1000° C. is introduced into the reactor containing at least one thin rod and is irradiated by means of UV light, as a result of which halogen and hydrogen radicals arise and the volatile halides that form are removed from the reactor.

### BACKGROUND

The invention relates to a method for producing polycrystalline silicon rods.

Polycrystalline silicon (for short: polysilicon) serves as starting material in the production of monocrystalline silicon by means of crucible pulling (Czochralski or CZ method) or by means of zone pulling (float zone or FZ method). Said monocrystalline silicon is separated into wafers and, after a large number of mechanical, chemical and chemomechanical processing stages, is used in the semiconductor industry for the manufacture of electronic components (chips).

In particular, however, polycrystalline silicon is required to an increased extent for the production of mono- or multicrystalline silicon by means of pulling or casting methods, wherein said mono- or multicrystalline silicon serves for the manufacturer of solar cells for photovoltaics.

The polycrystalline silicon, often also called polysilicon for short, is usually produced by means of the Siemens process. In this case, in a bell-shaped reactor (“Siemens reactor”) thin rods composed of silicon are heated by direct current passage and a reaction gas containing a silicon-containing component and hydrogen is introduced.

The silicon thin rods usually have an edge length of 3 to 15 mm.

Examples of appropriate silicon-containing components include silicon halogen compounds such as silicon chlorine compounds, in particular chlorosilanes. The silicon-containing component is introduced together with hydrogen into the reactor. At temperatures of more than 1000° C., silicon is deposited on the thin rods. This results, finally, in a rod comprising polycrystalline silicon. DE 1 105 396 describes the basic principles of the Siemens process.

With the production of thin rods, it is known from DE 1 177 119 to deposit silicon on a carrier body composed of silicon (=thin rod) subsequently to separate a part therefrom and to use this separated part in turn as a carrier body for the deposition of silicon. The separation can be effected mechanically, e.g. by means of sawing apart, or electrolytically by means of a liquid jet.

During the mechanical separation of thin rods, however, the surface thereof is contaminated with metals and with boron, phosphorus, aluminum and arsenic compounds. The average contamination with B, P, Al and As is in the range of 60 to 700 ppta (parts per trillion atomic). The contaminated thin rod surface contaminates the first thermally deposited Si layers by virtue of dopants B, P, As on the surface of the thin rods being incorporated into the growing Si rod during the deposition of the first layers of polycrystalline silicon on the thin rod surface.

Therefore, it is usually necessary to subject the thin rods to surface cleaning before they can be used for the deposition of silicon. In this regard, DE 1 177 119 discloses cleaning mechanically, e.g. by sand blasting or chemically by etching.

Treatment of the thin rods in an etching tank composed of material with low contamination, e.g. plastic, by means of a mixture of HF and HNO₃, enables the surface contamination to be significantly reduced, to less than 15 pptw in the case of B, P, Al and As. However, this purity is not sufficient for high-impedance FZ rods.

EP 0 548 504 A2 likewise describes a cleaning method wherein HF and HNO₃ are used for cleaning silicon.

Another cleaning method is known from DE 195 29 518 A1. In that case, polycrystalline silicon is firstly cleaned using a mixture of aqua regia (mixture of HCl and HNO₃) and is then subjected to additional cleaning using HF.

Particularly stringent requirements in respect of purity are made of thin rods used for the deposition of polycrystalline Si rods as starting material for zone pulling. According to U.S. Pat. No. 6,503,563 B1, FZ thin rods, after mechanical processing, are firstly etched by means of HF-HNO₃, rinsed with ultra pure water, dried and then stored in an inert gas container (N₂, He, preferably Ar) closed under excess pressure. In a later step, crystalline silicon is deposited on the thin rod by means of plasma CVD.

As a result of the handling of the thin rods during transport from the HF/HNO₃ etching installation to the inert gas container and from the latter to the CVD reactor, however, dopants can deposit again on the thin rod surface.

DE 27 25 574 A1 discloses preheating a silicon carrier by means of a heating medium (hydrogen, argon or helium). The gases—used in a high-purity state—prevent a contamination of silicon. In this case, the silicon carrier is heated to a temperature of approximately 400° C. Starting from this temperature, silicon becomes conductive and enables electrical heating by conducting through electric current, but no cleaning effect can be achieved at the thin rod surface under these conditions.

DE 1 202 771 discloses a method wherein in the context of a Siemens process, by regulating the proportion of hydrogen halide in the gas mixture, an upper layer of the carrier body is deposited in a first step and silicon is deposited in a second step. In the first step, the carrier body is heated to a temperature of approximately 1150° C. until the oxide skin is reduced.

It had already been known from U.S. Pat. No. 6,107, 197 to remove a silicon layer contaminated with carbon by exposing the contaminated layer to chlorine or hydrogen radicals, the chlorine or hydrogen radicals being produced by chlorine or hydrogen gas being led past a heated filament. The radicals are produced more efficiently by this means than by UV radiation. In order that hydrogen and chlorine radicals are formed in a manner sufficient for thin rod cleaning, a high decomposition temperature of above 1000° C. is required, as disclosed by DE 1 202 771.

Therefore, the object of the invention was to avoid the above-described disadvantages, that is to say high thin rod temperature, handling-dictated contamination of the cleaned thin rods during temporary storage until deposition, and insufficient cleaning effect at the surface of the incorporated thin rods, and to improve the prior art.

### DESCRIPTION OF THE INVENTION

The object is achieved by means of a method for producing polycrystalline silicon rods by deposition of silicon on at least one thin rod in a reactor, wherein, before the silicon deposition, hydrogen halide at a thin rod temperature of 400-1000° C. is introduced into the reactor containing at least one thin rod and is irradiated by means of UV light, as a result of which halogen and hydrogen radicals arise and the volatile halides that form are removed from the reactor.

Preferably, the deposition of silicon on the thin rod starts directly after the cleaning process by means of halogen and hydrogen radicals.

However, if it is intended to carry out the deposition only at a later point in time, which is likewise preferred, the thin rod is stored in an inert atmosphere. By way of example, a CO₂ atmosphere is suitable for this purpose. Suitable inert gases likewise include N₂ or Ar.

The storage is preferably effected in tubes closed in an airtight fashion and composed of quartz, HDPE or PP under excess pressure.

In the context of the invention, the halogen and hydrogen radicals are produced by decomposition of hydrogen halide by means of UV light.

What is advantageous about the method according to the invention is the fact that the thin rod surface contaminated with atmospheric pollutants is cleaned prior to the deposition under controlled conditions.

Dopants are removed from the reactor by radical reactions as volatile halides (e.g. PCl₃, BCl₃, AsCl₃) and hydrides (PH₃, BH₂, B₂H₆, AsH₃). A mixture e.g. of HBr—HCl or HJ-HCl is irradiated at low temperatures in H₂ atmosphere with UV (e.g. having a wavelength of 200-400 nm, preferably 254 nm) in order to clean and passivate the thin rods prior to the deposition.

The chlorine and hydrogen radicals remove the last residue of the boron, phosphorus, aluminum and arsenic traces from the silicon surface.

If the cleaned thin rods are not used immediately afterward, the thin rods cleaned in this way are stored in tubes closed in a gastight fashion and composed of quartz, HDPE or PP under inert gas excess pressure such as e.g. CO₂, N₂ or argon excess pressure, in order to obtain lower dopant contamination of the deposited silicon rods.

A low dopant concentration in the deposited silicon rods is an important quality criterion for the further processing of the silicon rods after the zone-pulling and crucible-pulling method to form dislocation-free single crystals.

In particular, a low dopant concentration in the raw silicon rods is necessary for producing single crystals having deliberately set and constant resistance values.

Furthermore, ultra high-purity thin rods are important for high dislocation-free FZ yields with high resistance.

The reaction of the halogen and hydrogen radicals produced with aluminum-, boron-, phosphorus- and As-containing surface contaminants to form volatile halides and hydrides is essential to the success of the invention.

The principles of the Siemens process are described in detail in DE 10 2006 037 020 A1 to the entire scope of which reference is made and which is part of the disclosure of this invention.

According to DE 10 2006 037 020 A1, starting from the opening of the deposition reactor for demounting a first carrier body with deposited silicon until the closing of the reactor for depositing silicon on a second carrier body, an inert gas is introduced through the feed line and the discharge line into the open reactor.

The method according to the invention refines the product properties as a result of additional surface cleaning of the thin rods after the reactor has been rendered inert.

### BRIEF DESCRIPTION OF THE DRAWING

The invention is illustrated below with reference to a figure.

FIG. 1 schematically shows the construction of an apparatus for carrying out the method.

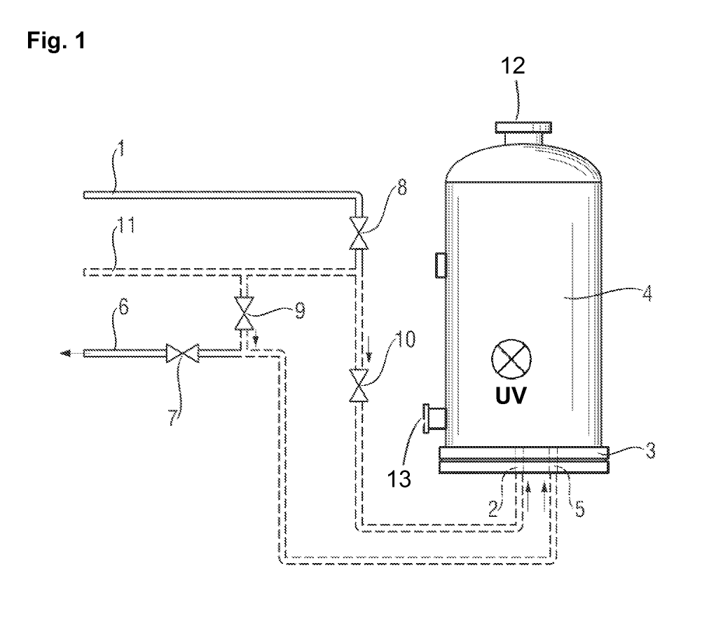

The typical construction of a Siemens reactor is involved.

Such a reactor comprises a feed line for a reaction gas 1 with a shut-off valve 8, said line leading via a feed opening 2 through the baseplate 3 into a reactor 4, and also a discharge line for an exhaust gas 6, said line leading through a discharge opening 5 in the baseplate 3 of the reactor 4 via a shut-off valve 7 into the open or to a conditioning system, wherein an inert gas line 11 joins the feed line 1 downstream of the shut-off valve 8, said inert gas line being regulatable by means of a shut-off valve 10, and an inert gas line 11 joins the discharge line 6 upstream of the shut-off valve 7, said inert gas line being regulatable by means of a shut-off valve 9.

### COMPARATIVE EXAMPLE

During the batch change or incorporation of the thin rods, feed and discharge lines and also the bell in an open state were purged with inert gas (nitrogen).

The deposition itself was effected from trichlorosilane (TCS) as described in DE 12 09 113 or DE 196 08 885 (“ignition”).

Once the poly rods had grown to the desired target diameter, the supply of trichlorosilane was interrupted and the reactor was cooled to room temperature and rendered inert.

After demounting, samples were prepared from the finished poly rods in accordance with SEMI MF 1723-1104 (Oct. 23, 2003) and were tested for dopants in accordance with the standard SEMI MF 397-02 (resistivity Oct. 22, 2003) and SEMI MF 1389-0704 (P content per photoluminescence Oct. 22, 2003).

The resistivity was 980 ohmcm with a P content of 33 ppta. The gradient mᵣₕₒ was 150 ohmcm/mm (for a definition of mᵣₕₒ cf. DE 10 2006 037 020 A1 ([0010]-[0012]).

### EXAMPLE

The reactor is prepared, as in example 1.

After the reactor 4 has been assembled tightly again a UV lamp (e.g. Ren-Ray 3SC-9 or Hanovia SC2537) is introduced in a sealed manner through the flange 12 or through the viewing glass 13.

Subsequently, after the closure of the valve 9 and opening of the valve 8 with valve 10 open, via the reaction gas line 1, a mixture of HBr—HCl—H₂ in a volumetric ratio of 0.00001:0.1:0.9 to 0.01:0.09:0.9 at atmospheric pressure is introduced with a volumetric flow rate of 85 Nm/h and disposed of via the exhaust gas line 6.

The flowing HX—H₂ mixture is irradiated by the UV lamp and the thin rod surfaces are treated for 30 min with the irradiated mixture at room temperature.

After this treatment, valve 8 is closed, the UV lamp is removed from the reactor 4 under N₂ inert gas flow and the reactor 4 is rendered inert again via the inert gas line 11 and exhaust gas line 6.

In this state, the deposition is then performed, as described in example 1.

The demounted rods exhibited a resistivity of >1100 ohmcm with a P content of <26 ppta. The gradient values mᵣₕₒ were >150 ohmcm/mm.

What is claimed is:

1. A method for producing polycrystalline silicon rods by deposition of silicon on at least one thin rod in a reactor, wherein, before the silicon deposition, hydrogen halide at a thin rod temperature of 400-1000° C. is introduced into the reactor containing at least one thin rod and is irradiated with UV light, such that halogen and hydrogen radicals arise and volatile halides and hydrides that form are removed from the reactor.

2. The method as claimed in claim 1, wherein, after the volatile halides and hydrides are removed, silicon is deposited on the at least one thin rod.

3. The method as claimed in claim 1, wherein, after the volatile halides and hydrides are removed, the at least one thin rod is first removed from the reactor and stored in a tube closed in an airtight fashion and comprising an inert atmosphere and, at a later point in time, is introduced into a reactor again in order to deposit silicon on the at least one thin rod.

4. The method as claimed in claim 1, wherein reactor and gas feed and discharge lines in the reactor are purged with an inert gas before the introduction of hydrogen halide.

5. The method as claimed in claim 1, wherein the irradiation is effected by a UV lamp which is inserted into the reactor in a manner sealed by a flange or a viewing glass.

6. The method as claimed in claim 1, wherein, after the removal of the volatile halides and hydrides from the reactor and before a deposition of silicon on the at least one thin rod, reactor and gas lines are purged with an inert gas.

7. The method as claimed in claim 3, wherein reactor and gas feed and discharge lines in the reactor are purged with an inert gas before the introduction of hydrogen halide.

8. The method as claimed in claim 7, wherein the irradiation is effected by a UV lamp which is inserted into the reactor in a manner sealed by a flange or a viewing glass.

9. The method as claimed in claim 8, wherein, after the removal of the volatile halides and hydrides from the reactor and before a deposition of silicon on the at least one thin rod, reactor and gas lines are purged with an inert gas.
